(19) United States
(12) Patent Application Publication
(10) Pub. No.: US 2026/0109835 A1
(43) Pub. Date: Apr. 23, 2026

(54) Encapsulation of Modifiers in Depolymerized Products

(71) Applicant: GreenMantra Recycling Technologies Ltd., Brantford (CA)

(72) Inventor: Domenic Di Mondo, Brampton (CA)

(21) Appl. No.: 19/429,093

(22) Filed: Dec. 22, 2025

Related U.S. Application Data
(63) Continuation of application No. 16/840,414, filed on Apr. 5, 2020, now Pat. No. 12,534,589.
Application No. 16/840,414 is a continuation of application No. PCT/CA2018/051517, filed on Nov. 28, 2018.
(60) Provisional application No. 62/591,434, filed on Nov. 28, 2017.

(51) Int. Cl. C08J 11/12; C08J 3/20; C08J 11/16; C08K 3/04

(52) U.S. Cl. CPC C08J 11/12; C08J 3/203; C08J 11/16; C08J 2323/06; C08J 2325/06; C08J 2391/06; C08J 2421/00; C08K 3/042

(57) ABSTRACT

A method of encapsulating modifiers in a depolymerized product is disclosed. In some embodiments the material undergoing depolymerization is one of polypropylene, polystyrene, and/or polyethylene. In some embodiments, the material is composed, at least partially, of recycled material. In some embodiments, the encapsulated modifiers are added to a formulation such as an asphalt, plastic lumber, plastic wood composite, a plastic formulation, a rubber formulation, an ink formulation, a coating formulation, and/or an adhesive formulation.

### CROSS-REFERENCE TO RELATED APPLICATION

This application claims priority to and is a continuation of U.S. application Ser. No. 16/840,414, filed Apr. 5, 2020, entitled “Encapsulation of Modifiers in Depolymerized Products”. The '414 application claims priority to and is a continuation of international application No. PCT/CA2018/051517, filed on Nov. 28, 2018, entitled “Encapsulation of Modifiers in Depolymerized Products”. The '517 application claimed priority benefits from U.S. provisional patent application Ser. No. 62/591,434 filed on Nov. 28, 2017, also entitled, “Encapsulation of Modifiers in Depolymerized Products”. This application also claims priority to the '517 and '434 applications. The '414, '517 and '434 applications are hereby incorporated by reference herein in their entireties.

### FIELD OF THE INVENTION

The present invention relates to methods of encapsulating modifiers, the resulting encapsulated-modifier granules, methods of utilizing the encapsulated-modifier granules with formulations, and formulations made from utilizing encapsulated-modifier granules. In some embodiments, the formulations are asphalt formulations, and/or the modifiers are asphalt modifiers. In some embodiments, the formulations are wood-plastic composites. In some embodiments, the formulations are polyethylene, polypropylene, and/or polystyrene plastic processing or compounding. In other embodiments, the formulation can be rubber compounding, such as ABS, SBS, or ABS rubber compounding.

In some embodiments, the formulations are ink and/or coatings. In some embodiments, the inks are energy curable inks. In some embodiments, the inks are UV curable inks. In some embodiments, the inks are water based. In some embodiments, the inks are solvent based.

In some embodiments, the inks/coatings can be used for inkjet, overprint, lithography, flexography, gravure, screen and/or digital printing.

In some embodiments, the formulations are adhesives. In some embodiments, the formulations are hot-melt formulations, such as hot-melt adhesives. In some embodiments, the formulations are solvents. In some embodiments, the formulations are emulsions. In some embodiments, the formulations are pressure-sensitive inks and/or coatings. In some embodiments, the formulations are UV cured inks and/or coatings. In some embodiments, the formulations are water-based formulations. In some embodiments, the formulations are epoxies.

In many instances, formulations, such as asphalt compositions, include multiple components including modifiers such as additives, fillers, rubbers, and plastics. Often, these components have limited solubility/compatibility with each other.

It can be complex and tedious to mix the components together to achieve uniformity. In many embodiments, uniform distribution can be necessary for maintaining certain desired properties of a given formulation. Encapsulation is one way to improve the distribution of a given component, such as a modifier, in a formulation. Encapsulation of one material (the core) by another material (the shell) can help contain, protect, and distribute the core material during incorporation into a formulation.

By way of example, encapsulated asphalt-modifiers are used in many industries including, but not limited to, roofing, pavement, sealing, and other industries that utilize asphalt. However, traditional encapsulation methods of encapsulating asphalt-modifiers, such as using asphalt or plastic as the shell, have many drawbacks, including but not limited to, difficulty blending and forming the material into a product that is solid and stable for bulk storage at various temperatures. When modifiers are added independently (one after the other) into a formulation they can increase both the cost and time required to manufacture the desired formulation. In addition, these modifiers often must be kept at specific concentrations to guarantee their adequate dispersion into a formulation.

The use of polymer or mineral based modifiers can also require the use of expensive equipment (such as high-shear mixers) and for powders (dust mitigation systems and more robust fire prevention) which not only adds to the manufacturing costs but can also raise safety concerns of producing the desired product. Moreover, modifiers can have negative environmental impacts.

In addition, modifiers can be incompatible for particular formulations and/or difficult/dangerous to store. For example, in many asphalt formulations various fillers and fire retardants such as, but not limited to, calcium carbonate, anti-oxidant, silica, and graphite are often stored in powder form. Adding the modifiers in a powder form to an asphalt blend can be dangerous as the powder can be flammable and/or cause respiratory issues.

What is needed is a way of encapsulating modifiers, so the modifiers can be easily stored prior to use. In addition, during use the encapsulated modifiers can be dispersed uniformly, or at least near uniformly, in the formulations. This encapsulation can also protect workers and equipment from unneeded exposure to harmful modifiers or powders.

### SUMMARY OF THE INVENTION

In some embodiments, an encapsulated-modifier granule includes a shell made of a depolymerized product; and at least one first-modifier located in the shell. In some embodiments, the encapsulated-modifier granule can further include at least one second-modifier located in the shell wherein the first-modifier and the second-modifier are different types of materials. In some embodiments, the encapsulated-modifier granule is spherical. In other embodiments, the encapsulated-modifier granule is cylindrical, hexagonal, or irregularly shaped.

In some embodiments, the polymeric material that is depolymerized can be at least one of polyethylene, polypropylene, polyethylene terephthalate, ethylene-vinyl acetate, polyphenylene ether, polyvinyl chloride, polystyrene, lignin, nylon, and/or cellulose. In some embodiments, the depolymerized product is a polymer.

A method of forming an encapsulated-modifier granule can comprise depolymerizing a feedstock material to create a depolymerized product and mixing at least one modifier in with the depolymerized product to create an encapsulated-modifier granule. In some embodiments, the resulting encapsulated-modifier granule can be added to a formulation. The formulation can be, among other things, an asphalt, wood-plastic composite, ink, coating, adhesive, thermoplastic composite, and/or rubber compound.

In some embodiments, the depolymerizing process is conducted via a catalytic process. In some embodiments, the depolymerizing process utilizes a [Fe—Cu—Mo—P]/Al₂O₃ catalyst. In some embodiments, the depolymerizing process is conducted via thermal depolymerization. In some embodiments, the depolymerizing process is conducted via free radical initiators and/or exposure to radiation, such as ionizing radiation. In some embodiments, the radiation is produced via an electron beam. In some embodiments, the initiator is an organic peroxide. In some embodiments, the depolymerization process is conducted, at least in part, via plasma depolymerization.

In some embodiments, the feedstock is selected from polyethylene, polypropylene and/or polystyrene materials. In at least some embodiments, the feedstock is at least partially comprised of recycled material, scrap material and/or reclaimed material.

In at least some embodiments, the depolymerized product is a polymer. In some embodiments, the depolymerized product is a wax. In some embodiments, the depolymerized product is a styrenic polymer.

In some embodiments the modifier is micronized, shredded and powder tire rubber, waxes, expandable carbon nano-tubes, dispersants, secondary acrylamides, tertiary acrylamides, acrylates, ketone resins, monomers, cross-linkable monomers, functional monomers, oligomers, cross-linkable oligomers, functional oligomers, polyacrylate polymers, silicones, surfactants, acrylic monomers, methacrylic monomers, flame-retardant additives, ink additives, flow additives, release additives, sulphur inhibitors, cross-linking agents, extenders, oxidants, antioxidants, hydrocarbons, antistripping agents, defoamers, styrene-butadiene-styrene (SBS), emulsifiers, calcium carbonates, pigments (such as recycled pigments and/or virgin pigments, such as carbon black), slip agents, ethylenically unsaturated monomers, cyclic lactams, photoinitiators, dyes (such as azo, xanthene and/or azine dyes), shelf-life stabilizers, carbonates, wetting agents, flow agents, de-aerators, and/or asphalt aggregate materials (such as sand, clay, and/or other fillers).

### BRIEF DESCRIPTION OF THE DRAWINGS

FIG. 1 is a schematic of a method of encapsulating modifiers and adding the encapsulated-modifier granules into a formulation.

FIG. 2 is a cutaway perspective view of two types of modifiers encapsulated in a depolymerized product to create an encapsulated-modifier granule.

### DETAILED DESCRIPTION OF ILLUSTRATIVE EMBODIMENT(S)

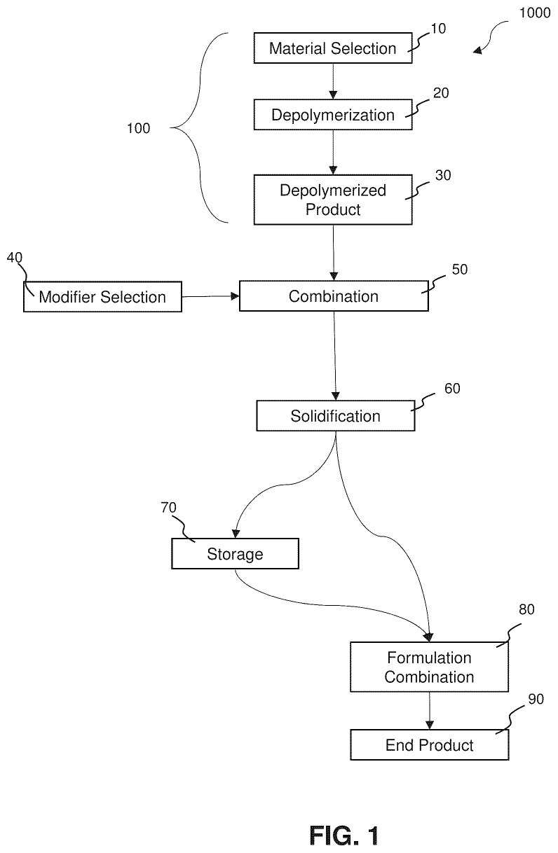

Turning to FIG. 1, Method 1000 is shown for encapsulating modifiers. In some embodiments the encapsulated modifiers are added to a formulation. In some embodiments, the formulation can be an asphalt. In other embodiments, the formulation can be a wood-plastic composite. In other embodiments, the formulation can be an ink and/or coating. In other embodiments, the formulation can be an adhesive. In other embodiments, the formulation can be a thermoplastic processing. In other embodiments, the formulation can be rubber compounding, such as ABS, SBS, or ABS rubber compounding. In some embodiments, the formulation can be a polypropylene, polyethylene, and/or polystyrene plastic-based processing and/or compounding formulation.

Section 100 of method 1000 involves the depolymerization of a feedstock to create a depolymerized product. In at least some embodiments, a feedstock is chosen at Material Selection Stage 10 and is depolymerized at Depolymerization Stage 20 to create a depolymerized product at Depolymerized Product Stage 30. In some embodiments, the depolymerized product is a polymer.

In some embodiments, the feedstock can be a polymeric material. In some embodiments, the polymeric material can include polyethylene, polypropylene, and/or polystyrene material.

In some embodiments, the polymeric material can be high density polyethylene (HDPE), low density polyethylene (LDPE), linear low-density polyethylene (LLDPE), or other variations and combinations polyethylene including cross-linked polyethylene.

In some embodiments, lower levels of polystyrene, polyethylene terephthalate (PET), ethylene-vinyl acetate (EVA), (polyvinyl chloride) PVC, (ethylene vinyl alcohol) EVOH, undesirable additives and/or contaminants, such as fillers, dyes, metals, various organic and inorganic additives, moisture, food waste, dirt, or other contaminating particles can be present in the feedstock. In some embodiments, the polymeric material includes combinations of LDPE, LLDPE, HDPE, and PP.

In some embodiments, the polymeric material can be divided evenly by weight between polyethylene and polypropylene.

In some embodiments, the polymeric material comprises recycled plastics. In some embodiments, the polymeric material comprises virgin plastics. In other or the same embodiments, the polymeric material comprises recycled plastics and/or virgin plastics.

In some embodiments, the polymeric material includes waste polymeric material feed. Suitable waste polymeric material feeds include mixed polyethylene waste, mixed polypropylene waste, and a mixture including mixed polyethylene waste and mixed polypropylene waste. The mixed polyethylene waste can include LDPE, LLDPE, HDPE, PP, or a mixture including combinations of LDPE, LLDPE, HDPE and PP. In some embodiments, the mixed polyethylene waste can include film bags, milk jugs or pouches, totes, pails, caps, agricultural film, and/or packaging material. In some embodiments, the waste polymeric material feed can include up to 10% of material that is other than polymeric material, based on the total weight of the waste polymeric material feed.

In some embodiments, the polymeric material can be one of, or a combination of, virgin polyethylene (any one of, or combinations of, HDPE, LDPE, LLDPE and medium-density polyethylene (MDPE)), virgin polypropylene, recycled polyethylene terephthalate, or post-consumer, or post-industrial, polyethylene or polypropylene (exemplary sources including bags, jugs, bottles, pails, and/or other items containing PE or PP).

In certain embodiments, the feedstock material can be a polystyrene. In some embodiments, the polystyrene can be recycled. In some embodiments, the recycled polystyrene can be a pellet made from recycled polystyrene foam and/or rigid polystyrene. Suitable waste polystyrene material includes, but is not limited to, expanded, and/or extruded polystyrene foam, and/or rigid products. Virgin polystyrene can also be used. In some embodiments, the polystyrene has a low molecular weight. In some embodiments, the polystyrene is expanded polystyrene, general purpose polystyrene, high impact polystyrene and/or polystyrene foam. In some embodiments, the polystyrene is composed of acrylonitrile, butadiene and styrene.

In some embodiments, the polystyrene material can be dissolved in certain solvents to create products with various properties. In some embodiments, organic solvents, such as toluene, xylenes, cymenes, or terpinenes, are used to dissolve the polystyrene before it undergoes depolymerization within the reactor bed/vessel. In certain embodiments, the desired product can be isolated via separation or extraction and the solvent can be recycled.

In some embodiments, the polystyrene feed has an average molecular weight between an inclusive range of about 100000 amu to 500000 amu.

In some embodiments, the polyethylene feed has an average molecular weight between an inclusive range of about 100000 amu to 500000 amu.

In some embodiments, the polypropylene feed has an average molecular weight between an inclusive range of about 100000 amu to 500000 amu.

In some embodiments, the depolymerized product can be made by catalytic depolymerization of the polymeric material during Depolymerization Stage 20. In some embodiments, the depolymerized product can be made by thermally degrading the polymeric material during Depolymerization Stage 20.

In some embodiments, the depolymerizing process is conducted via free radical initiators and/or exposure to radiation, such as ionizing radiation during Depolymerization Stage 20. In some embodiments, the radiation is produced via an electron beam. In some embodiments, the initiator is an organic peroxide. In some embodiments, the depolymerization process is conducted, at least in part, via plasma depolymerization.

In some embodiments, the Depolymerization Stage 20 involves thermal, catalytic, radiation and/or initiator depolymerization.

In some embodiments the depolymerization process utilizes a catalyst such as [Fe—Cu—Mo—P]/Al₂O₃, Zeolite or alumina supported systems, and/or thermal depolymerization. In some embodiments, the catalyst can be contained in a permeable container.

In some embodiments, the depolymerized product can be a polymer, such as a wax, grease, oligomer, and/or styrenic polymer.

In at least some embodiments, the depolymerized product can be compatible with asphalt, plastic wood composite, asphalt modifiers, plastic wood composite modifiers, plastic formulations used in plastic compounding/processing, rubber formulations used in rubber compounding/processing, thermoplastic compounding/processing, various inks, various coatings, and/or various adhesives. In some embodiments, use of the depolymerized product as the shell reduces the rotational viscosity of the resulting formulation.

In some embodiments, the depolymerized product can be compatible with asphalt formulations used in roofing asphalts, paving asphalts, crack fillers, adhesives, and/or other products for waterproofing and joint sealing. In some embodiments, the depolymerized product can be compatible with oxidized asphalt formulations, such as coating-grade asphalt and mopping-grade asphalt, and non-oxidized asphalt, such as saturant-grade asphalt.

Due to the nature of depolymerization, the depolymerized product(s) can be created with a wide spectrum of hardness and melting points. This allows for the creation of formulation-specific depolymerized products.

In at least some embodiments, a formulation can require both a modifier and a depolymerized product. In at least some of these embodiments, an encapsulated modifier can be used to remove the need to add both the modifier and the depolymerized product as separate components of the formulation and/or in separate steps.

In at least some embodiments, the depolymerized products provide hard but not brittle encapsulation media for modifiers for storage or direct blending into formulations. Modifiers encapsulated with depolymerized products can lead to a more uniform dispersion of other modifiers in the formulation. In at least some embodiments, such as embodiments in which the formulation is an asphalt, this greater dispersion creates more stable formulations, with improved physical properties, including, but not limited to, higher softening points, harder formulations, and/or lower viscosities.

In some embodiments, when modifiers encapsulated with depolymerized product are added to an asphalt formulation, emission of volatile organic compounds can be reduced.

In some embodiments, when modifiers encapsulated with depolymerized product are added to an asphalt formulation, the performance grade of the asphalt formulation can be increased due to improved (increased) stability at higher temperatures.

In some embodiments, when modifiers encapsulated with depolymerized product are added to an asphalt formulation, the performance of the asphalt formulation is improved. Specifically, modifiers encapsulated with depolymerized product can increase resistance to flow at high temperatures, increase softening point, and/or decrease penetration of asphalt formulations.

In some embodiments, when modifiers encapsulated with depolymerized product are added to an asphalt formulation, the time required for asphalt oxidation can be reduced.

In some embodiments, when modifiers encapsulated with depolymerized product are added to ink and/or coating formulations, the modifier is more evenly dispersed within the formulation matrix.

In some embodiments, when modifiers encapsulated with depolymerized product are used in ink and/or coating formulations, the modifier is easier and/or safer to handle.

In some embodiments, when modifiers encapsulated with depolymerized product are used in ink and/or coating formulations, the modifier and/or the formulation is more stable and/or has a longer shelf-life.

In some embodiments, encapsulating modifiers with a depolymerized product protects the modifier from oxidation and/or degradation often caused by oxygen and/or heat.

In some embodiments, when modifiers encapsulated with depolymerized product are used in ink and/or coating formulations, the resulting formulation has a lower formulation viscosity which, in turn, can allow for easier processing, blending, and/or the ability to increase the modifier and/or external additive loading.

At Modifier Selection Stage 40, at least one modifier can be selected. Modifiers can be selected based on their various properties.

Modifiers can include, but are not limited to micronized, shredded and powder tire rubber, waxes, expandable carbon nano-tubes, dispersants, secondary acrylamides, tertiary acrylamides, acrylates, ketone resins, monomers, cross-linkable monomers, functional monomers, oligomers, cross-linkable oligomers, functional oligomers, polyacrylate polymers, silicones, surfactants, acrylic monomers, methacrylic monomers, flame-retardant additives, ink additives, flow additives, release additives, sulphur inhibitors, cross-linking agents, extenders, oxidants, antioxidants, hydrocarbons, antistripping agents, defoamers, styrene-butadiene-styrene (SBS), emulsifiers, calcium carbonate, pigments (such as recycled pigments and/or virgin pigments, such as carbon black), slip agents, ethylenically unsaturated monomers, cyclic lactams, photoinitiators, dyes (such as azo, xanthene and/or azine dyes), shelf-life stabilizers, carbonates, wetting agents, flow agents, de-aerators, and/or asphalt aggregate materials (such as sand, clay, and/or other fillers).

In some embodiments, the modifier can be an asphalt modifier.

In some embodiments, the modifier(s), such as the monomer(s) and/or oligomer(s), can have polar and/or polar charged groups.

In Combination Stage 50 at least one modifier and one depolymerized product are blended together in a mixing vessel. In at least some embodiments the depolymerized product can be in a liquid, semiliquid, or solid form. In at least some embodiments, the modifier(s) is/are added in the inclusive range of 0.001% to 65% wt. % of the total combined product. In some embodiments, the range can be between an inclusive range of about 0.0001% to 99.999% wt. % of the total combined product. In some preferred embodiments, the range can be between an inclusive range of about 60% to 70% wt. % of the total combined product. In some more preferred embodiments the range can be between an inclusive range of about 40% to 50% wt. % of the total combined product.

In at least some embodiments, modifiers are mixed in-line with the depolymerized product. Some advantages of using depolymerization products in-line is a decrease in cost and reduction in the amount of energy used.

In at least some embodiments involving asphalt formulations, the depolymerization product can act as a compatibilizer between the modifier, asphalt binder, and/or aggregate by lowering the surface energy in the boundary layer. This prevents, or at least reduces, agglomeration and aids in distributing the modifier particles uniformly throughout the asphalt formulation. A similar phenomenon can occur when depolymerization products are used in plastic wood composites, plastic formulations used in plastic compounding/processing, or rubber formulations used in rubber compounding/processing.

In at least some embodiments involving ink/coating formulations, the depolymerized product can be used to incorporate modifiers that can be used to modify flow, surface tension, gloss, pigment wetting and/or abrasion resistance.

In some embodiments, such as those involving ink and/or coating formulations, the depolymerized product can act as a compatibilizing agent.

In some embodiments, encapsulating a modifier in a depolymerized product before addition to the formulation can lead to improved performance than if the modifier and depolymerized product are added separately to the formulation.

In at least some embodiments, in Combination Stage 50 the mixing vessel can be heated to a temperature above the melting point of the depolymerization product(s). In some embodiments, the mixing vessel can be heated by means of electric external heaters, electric jackets, and/or steam jackets. In at least some embodiments, the depolymerization product provides consistent dispersion for the modifiers and encapsulates the modifiers.

In some embodiments, in Combination Stage 50, the semi-solid and/or solid depolymerized products can be mixed with modifiers. In some embodiments, this can be accomplished by the use of compression.

In some embodiments, the combination can be transferred into optional pelletizing equipment and/or various dimension slabs that can be grinded to a desired size at Solidification Stage 60. In at least some embodiments, the pellets are between an inclusive range of about 1 mm-30 mm in size. In some preferred embodiments, the pellets are between an inclusive range of about 1 mm to 10 mm in size.

In some embodiments, the encapsulated modifiers can be stored in Storage Stage 70 or directly mixed into various formulations at Formulation Combination Stage 80. A product can be created at End Product Stage 90. In some embodiments, the product created at End Product Stage 90 can be further modified.

In some embodiments, such as when the formulation is an asphalt, the percentage of the encapsulation product can be roughly 1% to 50% by weight of the asphalt formulation. In some preferred embodiments, the percentage of the encapsulation product can be roughly 1% to 20% by weight of the asphalt formulation. In other embodiments, where the formulation can be a plastic wood composite the percentage of the encapsulation product can be roughly 1% to 50% by weight of the plastic wood composite formulation. In some preferred embodiments, the percentage of the encapsulation product can be roughly 1% to 20% by weight of the plastic wood composite formulation. In some preferred embodiments, the percentage of the encapsulation product can be roughly 1% to 30% by weight of a plastic formulation used in plastic compounding/processing. In some preferred embodiments, the percentage of the encapsulation product can be roughly 1% to 30% by weight of a rubber formulation used in rubber compounding/processing. In other embodiments, where the formulation can be an ink formulation the percentage of the encapsulation product can be roughly 1% to 75% by weight of the ink formulation. In some preferred embodiments, the percentage of the encapsulation product can be roughly 10% to 60% by weight of the ink formulation.

In some embodiments, the encapsulation product can be compatible with asphalt formulations used in roofing asphalts, paving asphalts, crack fillers, adhesives, and/or other products for waterproofing and joint sealing. In some embodiments, the depolymerized product can be compatible with oxidized asphalt formulations, such as coating-grade asphalt and mopping-grade asphalt, and non-oxidized asphalt, such as saturant-grade asphalt.

Depolymerization products can be chosen to match specific viscosity, hardness, melting temperature, and/or dropping point ranges required for given applications. In at least some embodiments, Method 1000 allows for modifiers to be dispersed uniformly, thus eliminating, or at least reducing, the need for using modifying agents, high-shear mixers, and/or excessive energy consumption.

The above method can employ a variety of depolymerized products, including those with melt points between an inclusive range of about 90° C. to 170° C. and viscosities between an inclusive range of about 25 cps to 3000 cps. In some preferred embodiments, the depolymerized products employed have melting points between an inclusive range of about 110° C. to 130° C. and 150° C. to 170° C.

Encapsulation can allow for the reduction, if not complete elimination, of the use of powder modifiers. Powder modifiers can be dangerous, as they are often flammable and can cause respiratory issues. As a result, powder management equipment is often used when powder modifiers are added to formulations. This equipment can be expensive.

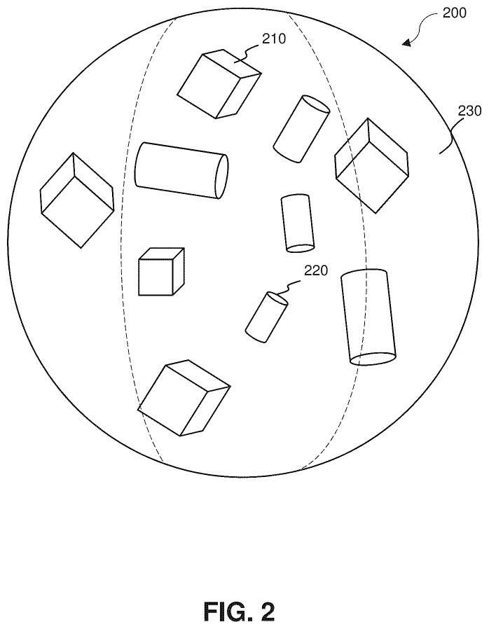

FIG. 2 is a cutaway perspective view of first modifier 210 and second modifier 220 encapsulated in depolymerized product 230 to create encapsulated-modifier granule 200. In some embodiments, first modifier 210 can be the same type as second modifier 220. In some embodiments, first modifier 210 and second modifier 220 are different types. In some embodiments, encapsulated-modifier granule 200 can be spherical. In some embodiments, encapsulated-modifier granule 200 can be cylindrical shaped.

### Specific Example 1

In one embodiment of the above method, 500 g of micronized tire rubber with an average diameter of 30 micron was mixed with 500 g of melted wax by stirring a paddle mixer at 30 rpm at 125° C. for five minutes.

The resulting product was then poured into 0.5″ (1.27 cm) diameter forms and allowed to solidify. The resulting product was able to be placed in a storage container before blending it into an asphalt formulation.

Remelting experiments demonstrated that the tire rubber integrity was maintained. This demonstrated that the process prevented, or at least reduced, agglomeration of the particles and/or modification of the particles. Remelting experiments also demonstrated that the 30-micron powder could be dispersed upon melting of the depolymerized product.

### Specific Example 2

In one embodiment of the above method, 500 g of carbon graphite powder was mixed with 500 g of melted wax by stirring a paddle mixer at 30 rpm at 125° C. for five minutes. The resulting product was then poured into a 0.5″ (1.27 cm) diameter form and allowed to solidify. The resulting product was able to be placed in a storage container before blending it into an asphalt formulation.

Remelting experiments demonstrated that the graphite particle did not agglomerate and its integrity was maintained and that the 30-micron powder could be dispersed upon melting of the depolymerized product.

Changes in melting point, viscosity, molecular weight, and/or polymer backbone structure of the depolymerized product can change the properties of a formulation. Properties can include, but not limited to, the force ductility, thermal stability, softening point, phase separation, and/or penetration of the formulation.

Encapsulating modifiers in depolymerized products can provide the following benefits including, but not limited to:
encapsulating hard to manage powder modifiers, in a preferred easier to handle larger form;
easing the disbursement of modifiers into formulations such as hot asphalt, reducing mixing or extrusion times;
improving the dispersion of modifiers;
allowing a pathway for use of harder to blend/higher viscosity polymer and rubber modifiers;
improving the performance and/or product quality of certain formulations, such as particular asphalt and plastic wood composite formulations, plastic formulations used in plastic compounding/processing, rubber formulations used in rubber compounding/processing various ink and coating formulations, and/or various adhesive formulations;
lowering the viscosity of certain inks and/or coating formulations which in turn can allow for easier processing, blending, and/or the ability to increase the modifier and/or external additive loading;
reducing emission of volatile organic compounds in some formulations such as asphalt formulations;
improving stability of some formulations such as asphalt formulations at higher temperatures;
improving the quality of asphalt formulations by increasing the asphalt resistance to flow at high temperatures and improving the hardness properties of the asphalt such as increasing the softening point and decreasing the penetration of the asphalt formulation;
reducing the time required for asphalt oxidation; and
reducing the manufacture cost of certain formulations, such as particular asphalt and plastic wood composite formulations, plastic formulations used in plastic compounding/processing, and/or rubber formulations used in rubber compounding/processing.

While particular elements, embodiments, and applications of the present invention have been shown and described, it will be understood, that the invention is not limited thereto since modifications can be made without departing from the scope of the present disclosure, particularly in light of the foregoing teachings.

What is claimed is:

1. An encapsulated-modifier granule comprising:
a shell made of a depolymerized product; and
a first-modifier located in said shell,
wherein said depolymerized product is formed by depolymerizing a feedstock via a depolymerization process.

2. The encapsulated-modifier granule of claim 1 wherein said encapsulated-modifier granule further comprises a second-modifier located in said shell.

3. The encapsulated-modifier granule of claim 2 wherein said first-modifier and said second-modifier are different types of modifiers.

4. The encapsulated-modifier granule of claim 1 wherein said encapsulated-modifier granule is spherical.

5. The encapsulated-modifier granule of claim 1 wherein said encapsulated-modifier granule is cylindrical shaped.

6. The encapsulated-modifier granule of claim 1 wherein said feedstock comprises a recycled polymer.

7. The encapsulated-modifier granule of claim 1 wherein said depolymerization process utilizes a catalyst.

8. The encapsulated-modifier granule of claim 1 wherein said depolymerized product is a wax.

9. The encapsulated-modifier granule of claim 1 wherein said encapsulated-modifier granule is hexagonal or irregularly shaped.

10. A method of forming an encapsulated-modifier granule comprising:
depolymerizing a feedstock material to create a depolymerized product via a catalytic process; and
mixing a modifier with said depolymerized product to create said encapsulated-modifier granule.

11. The method of claim 10 further comprising adding said encapsulated-modifier granule to a formulation.

12. The method of claim 11 wherein said formulation is a plastic lumber.

13. The method of claim 11 wherein said formulation is a plastic wood composite.

14. The method of claim 13 wherein said catalytic process utilizes a [Fe—Cu—Mo—P]/Al₂O₃ catalyst.

15. The method of claim 10 wherein said modifier is a flame-retardant.

16. The method of claim 10 wherein said feedstock material is at least one of a polyethylene, polypropylene, polyethylene terephthalate, ethylene-vinyl acetate, polyphenylene ether, polyvinyl chloride, polystyrene, lignin, nylon, or cellulose.

17. The method of claim 15 wherein said feedstock material comprises recycled material.

18. The method of claim 10 wherein said depolymerized product is a wax.

19. The method of claim 10 wherein said depolymerized product is a styrenic polymer.

20. The method of claim 10 wherein said modifier is a tire rubber.
